(19) United States
(12) Patent Application Publication
(10) Pub. No.: US 2009/0103256 A1
(43) Pub. Date: Apr. 23, 2009

(54) ELECTRONIC EQUIPMENT

(75) Inventors: Koichiro Takeguchi, Tokyo (JP); Shigeo Hayashi, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/135,065

(22) Filed: Jun. 6, 2008

(30) Foreign Application Priority Data
Oct. 19, 2007 (JP) 2007272986

(51) Int. Cl. G06F 1/16

(52) U.S. Cl. 361/679.27

(57) ABSTRACT

An electronic equipment includes: a main unit that is provided with a printed circuit board; a display unit that is provided with a display device; a hinge mechanism that is provided with a rotation shaft that connects the display unit to the main unit to be rotatable between a first position where the display unit is opened relative to the main unit and a second position where the display unit is closed relative to the main unit; an urging mechanism that urges the display unit toward the second position at a position between the first position and the second position; and a relaxation mechanism that is provided separately from the urging mechanism and relaxes an urging force applied to the display unit by the urging mechanism.

### CROSS-REFERENCE TO RELATED APPLICATIONS

This application is based upon and claims the benefit of priority from Japanese Patent Application No. 2007-272986, filed on Oct. 19, 2007, the entire content of which are incorporated herein by reference.

### BACKGROUND

1. Field

One embodiment of the invention relates to an electronic equipment that is provided with a main unit, a display unit, and an urging mechanism that urges the display unit toward the main unit.

2. Description of the Related Art

There is known a portable computer that is provided with a main unit, a display unit, and a hinge mechanism that pivotably connects the main unit and the display unit to allow the display unit to be opened and closed with respect to the main unit. In the portable computer, the display unit is urged toward the main unit immediately before completing the closing operation. The hinge mechanism has a convexed cam member having a convex part of a cam, a concaved cam member having a concave part of a cam, and a spring for urging the convexed cam member toward the concaved cam member.

In the portable computer, when the display unit is closed toward the main unit, the convex part of the convexed cam member is fitted into the concave part of the concaved cam member by the action of the spring. Accordingly, when the display unit is closed, the display unit is urged (pulled) toward the main unit and is retained in the closed state. Thus, for example, when a user carries the portable computer in the closed state, the display unit can be prevented from freely opened. An example of thus configured portable computer is disclosed in JP-A-2005-140152.

However, in the convention portable computer, the display unit is subjected to a large force as the display unit is urged toward the main unit as described above and thus impacting the main unit. Thus, a shock is repeatedly given to internal components of the portable computer, such as an internal hard disk drive and a liquid crystal display. Accordingly, the reliability of the portable computer will be adversely affected from a long-term viewpoint. Also, due to the swift closing of the display unit, the user might jam his or her finger between the display unit and the main unit.

### SUMMARY

According to one aspect of the present invention, there is provided an electronic equipment includes: a main unit that is provided with a printed circuit board; a display unit that is provided with a display device; a hinge mechanism that is provided with a rotation shaft that connects the display unit to the main unit to be rotatable between a first position where the display unit is opened relative to the main unit and a second position where the display unit is closed relative to the main unit; an urging mechanism that urges the display unit toward the second position at a position between the first position and the second position; and a relaxation mechanism that is provided separately from the urging mechanism and relaxes an urging force applied to the display unit by the urging mechanism.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate embodiments of the present invention and not to limit the scope of the present invention.

FIG. 1 is a perspective view to show a portable computer according to a first embodiment of the present invention at a first position.

FIG. 2 is a sectional view to show a hinge mechanism, an urging mechanism, and a relaxation mechanism of the portable computer shown in FIG. 1.

FIG. 3 is a perspective view to show a second hinge part of the hinge mechanism, the urging mechanism, and the relaxation mechanism shown in FIG. 2.

FIG. 4 is an exploded perspective view to show the urging mechanism shown in FIG. 3.

FIG. 5 is a sectional view to show a state in which the relaxation mechanism shown in FIG. 3 starts to operate.

FIG. 6 is a sectional view to show the relaxation mechanism shown in FIG. 3 in a state in which the display unit is at a second position.

FIG. 7 is a sectional view to show a state in which a relaxation mechanism of a portable computer according to a second embodiment of the present invention starts to operate.

FIG. 8 is a sectional view to show the relaxation mechanism shown in FIG. 7 in a state in which a display unit is at a second position.

FIG. 9 is a sectional view to show a hinge mechanism, an urging mechanism, and a relaxation mechanism of a portable computer according to a third embodiment of the present invention.

### DETAILED DESCRIPTION

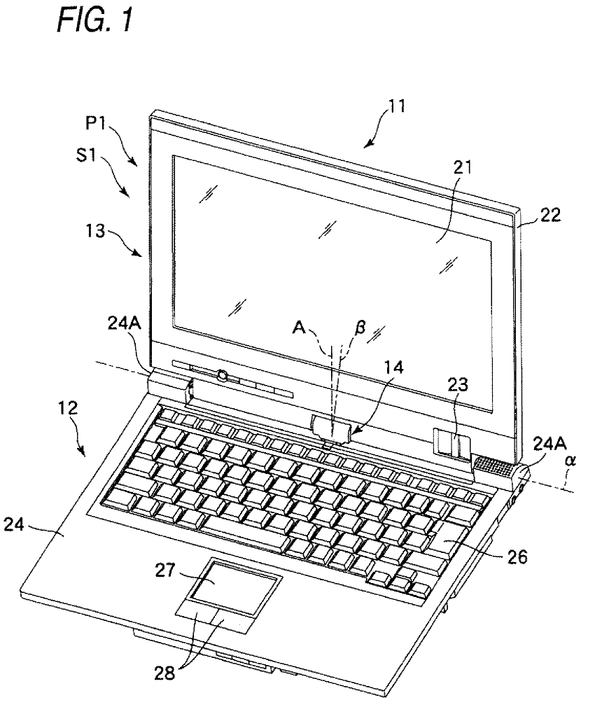

A first embodiment of an electronic equipment of the invention will be described with reference to FIGS. 1 to 6.

As shown in FIGS. 1 to 3, a portable computer 11, which will be described as an example of an electronic equipment according to the present invention, includes a main unit 12, a display unit 13, a hinge mechanism 14 that rotatably connects the main unit 12 and the display unit 13, an urging mechanism 15 that is provided adjacent to the hinge mechanism 14, and a relaxation mechanism 16 that relaxes urging force by the urging mechanism 15.

As shown in FIG. 1, the display unit 13 has a liquid crystal display 21, a cover 22 for covering the surroundings of the liquid crystal display 21, and a fingerprint authentication device 23 attached to the cover 22. A rotation shaft 33 (described later) of the hinge mechanism 14 allows the display unit 13 to rotate between a first position P1 where the display unit 13 is open relative to the main unit 12, as shown in FIG. 1, and a second position P2 where the display unit 13 is closed relative to the main unit 12, as shown in FIG. 6. A pivot 34 (described later) of the hinge mechanism 14 allows the display unit 13 to pivot in a horizontal direction between a first state S1 in which the liquid crystal display 21 faces the front as shown in FIG. 1 and a second state S2 in which the liquid crystal display 21 faces the rear.

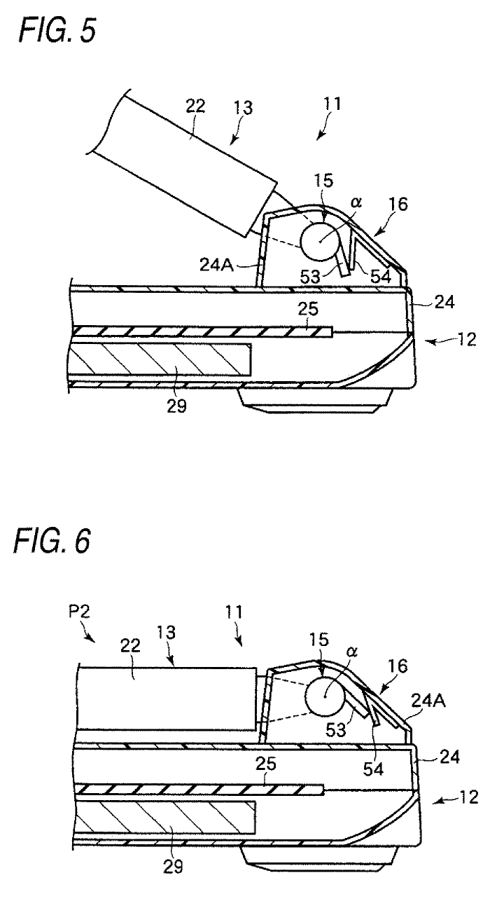

As shown in FIGS. 1 and 5, the main unit 12 has a cabinet 24 made of a synthetic resin, a printed circuit board 25 housed in the cabinet 24, a keyboard 26, a touch pad 27, and buttons 28 attached to the cabinet 24, and a hard disk drive 29 housed in the cabinet 24. The printed circuit board 25 is a so-called mother board, and circuit components, such as a CPU, are mounted thereon. The cabinet 24 surrounds and accommodates the printed circuit board 25. The cabinet 24 has a protruded portion 24A that protrudes toward the display unit 13 from top face of the main unit 12. The protruded portion 24A protrudes upward from the top face toward the display unit 11 to include an axis α of the rotation shaft 33, as described later in detail.

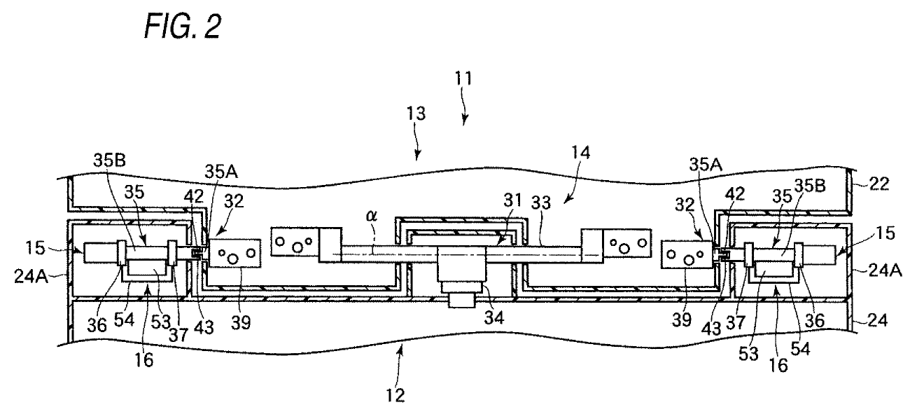

As shown in FIG. 2, the hinge mechanism 14 has a first hinge part 31 provided in the center and a pair of second hinge parts 32 provided at both left and right ends. The first hinge part 31 has the rotation shaft 33 for supporting the display unit 13 so as to allow the display unit 13 to rotate between the first position P1 and the second position P2 and the pivot 34 for supporting the display unit 13 so as to allow the display unit 13 to pivot roughly in the horizontal direction. The rotation shaft 33 can rotate on the axis a passing through the center of the rotation shaft 33. The pivot 34 can rotate on an axis β passing through the center of the pivot 34. The axis β is inclined toward the back with respect to a normal line A to the top face of the cabinet 24, and the direction in which the display unit 13 pivots is also inclined slightly with respect to the horizontal direction.

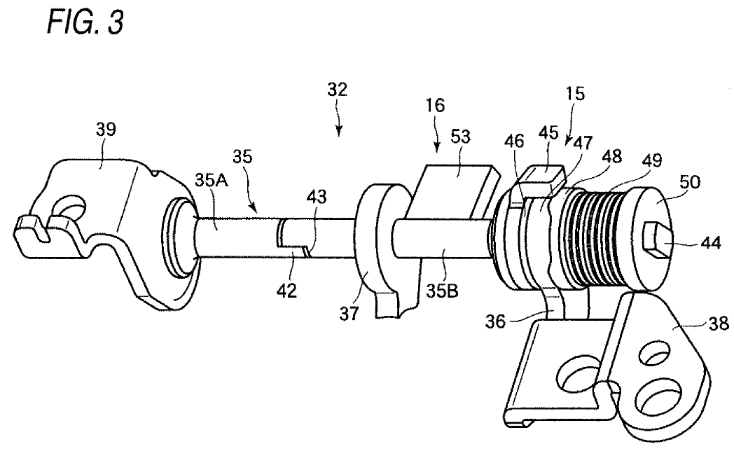

As shown in FIG. 3, the second hinge part 32 has a shaft part 35 provided on the same axis as the rotation shaft 33, a first bearing 36 and a second bearing 37 for supporting the shaft part 35, a first bracket 38 provided continuously with the first bearing 36, and a second bracket 39 provided continuously with one end of the shaft part 35. The first bracket 38 is fixed as it is screwed into the cabinet 24. The second bearing 37 is fixed to the cabinet 24 through a bracket (not shown). The second bracket 39 is fixed as it is screwed into the cover 22 of the display unit 13.

The shaft part 35 is formed of stainless steel, for example. It has a first portion 35A continuous with the second bracket 39 and a second portion 35B supported by the first bearing 36 and the second bearing 37.

The first portion 35A contains a protruded portion 42 projection toward the second portion 35B. The second portion 35B contains a groove 43 into which the protruded portion 42 is inserted. If the first portion 35A rotates, the second portion 35B also rotates in a state in which the protruded portion 42 of the first portion 35A is inserted into the groove 43 of the second portion 35B. If the display unit 13 pivots from the first state S1 to the second state S2 or pivots from the second state S2 to the first state S1, the first portion 35A of the shaft part 35 is detached from the second portion 35B into which the first portion 35A is inserted, and is inserted into the second portion 35B of the shaft part 35 on the opposite side.

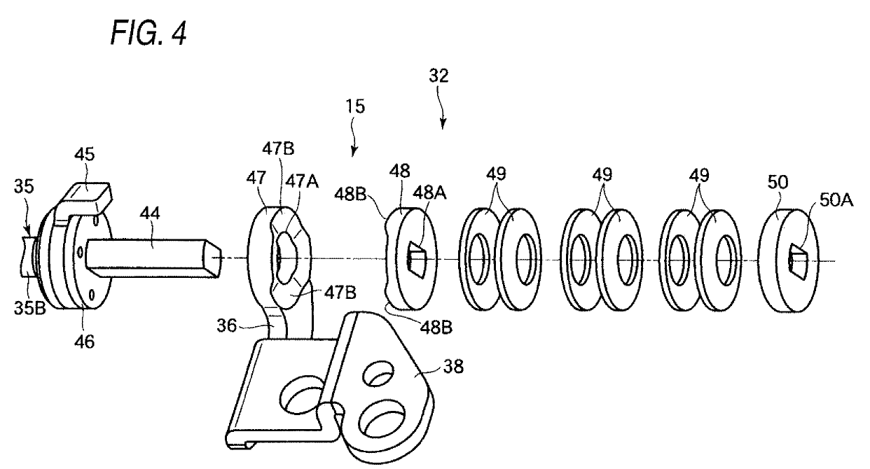

The urging mechanism 15 urges the display unit 13 at a position between the first position P1 and the second position P2 toward the second position P2. As shown in FIGS. 3 and 4, the urging mechanism 15 has a shaft 44 formed so as to continue with the shaft part 35 of the second hinge part 32, a stopper member 45 attached to a base end of the shaft 44, a friction plate 46 for giving a predetermined frictional force when the shaft 44 rotates, a cam part 47 formed in the first bearing 36, a disk-shaped cam member 48 abutted against the cam part 47, a plurality of disc springs 49 for urging the cam member 48 toward the cam part 47, and a fixing plate 50 for fixing the disc springs 49 to the shaft 44. The shaft 44 is formed roughly quadrangular in cross section. The stopper member 45 regulates the rotation angle of the display unit 13. The cam part 47 has a circular through hole 47A for allowing the shaft 44 to pass through. The shaft 44 drawn through the through hole 47A can rotate freely relative to the through hole 47A. On the other hand, the cam member 48 and the fixing plate 50 have fix holes 48A and 50A each having roughly the same shape as the cross-sectional shape of the shaft 44. If the shaft 44 is drawn through the fix holes 48A and 50A, the cam member 48 and the fixing plate 50 rotate together with rotation of the shaft 44.

The cam member 48 has a convex face 48B for causing an urging force to act on the display unit 13 to move toward the main unit 12 while the display unit 13 is at any position between the first position P1 and the second position P2. The cam part 47 has a concave face 47B into which the convex face 48B is fitted. The cam member 48 and the cam part 47 are formed each of stainless steel, for example. When the display unit 13 is at a position between the first position P1 and the second position P2, the convex face 48B of the cam member 48 is fitted into the concave face 47B of the cam part 47. As the convex face 48B is fitted into the concave face 47B, the display unit 13 receives an urging force toward the main unit 12, namely, toward the second position P2.

As shown in FIG. 3, the relaxation mechanism 16 is housed in the protruded portion 24A of the cabinet 24 and is provided independently of the urging mechanism 15. As shown in FIGS. 2, 3, and 5, the relaxation mechanism 16 has a flat rotation member 53. The rotation member 53 is monolithically formed with the shaft part 35 and is formed so as to project outward from the shaft part 35. The rotation member 53 rotates on the axis a with rotation of the rotation shaft 33. The relaxation mechanism 16 has an elastic body 54 that is pressed by the rotation member 53. The elastic body 54 is implemented as a plate spring formed of stainless steel. The elastic body 54 has a shape bent in a V-shape, for example. The elastic body 54 is adhered to the inner face of the protruded portion 24A of the cabinet 24.

Subsequently, the function and the operation of the relaxation mechanism 16 in the portable computer 11 of the embodiment will be described. When the display unit 13 is pulled in the direction of the main unit 12 by the action of the urging mechanism 15, the relaxation mechanism 16 decreases the rotation speed of the display unit 13. Accordingly, the relaxation mechanism 16 relaxes the shock produced when the display unit 13 hits the main unit 12.

As shown in FIG. 5, when the display unit 13 is about to be placed in the second position P2 from the first position P1 by the closing operation performed by the user, the urging mechanism 15 pulls the display unit 13 in the direction of the main unit 12. Immediately before the display unit 13 arrives at the second position P2, the relaxation mechanism 16 starts to operate and decreases the rotation speed of the rotation shaft 33. Specifically, as shown in FIG. 5, the rotation member 53 abuts the elastic body 54 in the proximity of a leading end of the rotation member 53. When the display unit 13 continues to rotate, the rotation member 53 rotates on the shaft part 35 and gradually crushes the elastic body 54. Accordingly, when the display unit 13 arrives at the second position P2, the elastic body 54 is pressed as shown in FIG. 6. The rotation speed of the display unit 13 is relaxed in reaction to pressing the elastic body 54, and the display unit 13 is gently pulled toward the second position P2.

According to the first embodiment, the portable computer 11 includes the main unit 12 having the printed circuit board 25, the display unit 13 having the display, the hinge mechanism 14 for joining the main unit 12 and the display unit 13, the hinge mechanism 14 containing the rotation shaft 33 for rotating the display unit 13 between the first position P1 where the display unit 13 is open relative to the main unit 12 and the second position P2 where the display unit 13 is closed relative to the main unit 12, the urging mechanism 15 for urging the display unit 13 at a position between the first position P1 and the second position P2 toward the second position P2, and the relaxation mechanism 16 provided independently of the urging mechanism 15 for relaxing the urging force of the urging mechanism 15.

The portable computer 11 according to the first embodiment is provided with the urging mechanism 15. Thus, for example, to carry the portable computer 11 with the display unit 13 placed in the second position P2, the display unit 13 is prevented from being opened by its own weight. Since the relaxation mechanism 16 provided separately from the urging mechanism 15, the urging force by the urging mechanism 15 can be appropriately weakened. Accordingly, a situation in which the display unit 13 hits with the main unit 12 due to a strong urging force acting on the display unit 13 can be prevented. In the first embodiment, the elastic body 54 is implemented as a plate spring, so that the effectiveness of the relaxation mechanism 16 can be finely adjusted by changing the hardness of the plate spring.

In this case, the relaxation mechanism 16 decreases the rotation speed of the rotation shaft 33 immediately before the display unit 13 arrives at the second position P2. According to the configuration, the action of pulling in the display unit 13 by the urging mechanism 15 is not hindered and the display unit 13 can be prevented from being closed with force relative to the main unit 12.

In this case, the main unit 12 has the cabinet 24 surrounding the printed circuit board 25, the cabinet 24 contains the protruded portion 24A projecting toward the display unit 13, and the relaxation mechanism 16 is housed in the protruded portion 24A. According to the configuration, the relaxation mechanism 16 is not exposed to the outside of the cabinet 24 and spoiling the appearance of the portable computer 11 as the relaxation mechanism 16 is provided can be prevented.

The relaxation mechanism 16 has the rotation member 53 rotating with rotation of the rotation shaft 33 and the elastic body 54 pressed by the rotating rotation member 53. According to the configuration, the relaxation mechanism 16 can be formed as a simple structure. The effectiveness of the relaxation mechanism 16 can be finely adjusted by changing the hardness of the plate spring of the elastic body 54. Accordingly, the case where the weight of the display unit 13 changes due to design change, etc., can be dealt with flexibly. Since the elastic body 54 forming a part of the relaxation mechanism 16 is housed in the protruded portion 24A, the appearance of the portable computer 11 is not spoiled if the elastic body 54 is provided.

The main unit 12 has the hard disk drive 29 housed in the cabinet 24. According to the configuration, the shock caused by pulling in the display unit 13 is relaxed, so that if the hard disk drive 29 is housed in the cabinet 24, applying a shock to the hard disk drive 29 can be prevented. Accordingly, the reliability of the portable computer 11 can be improved.

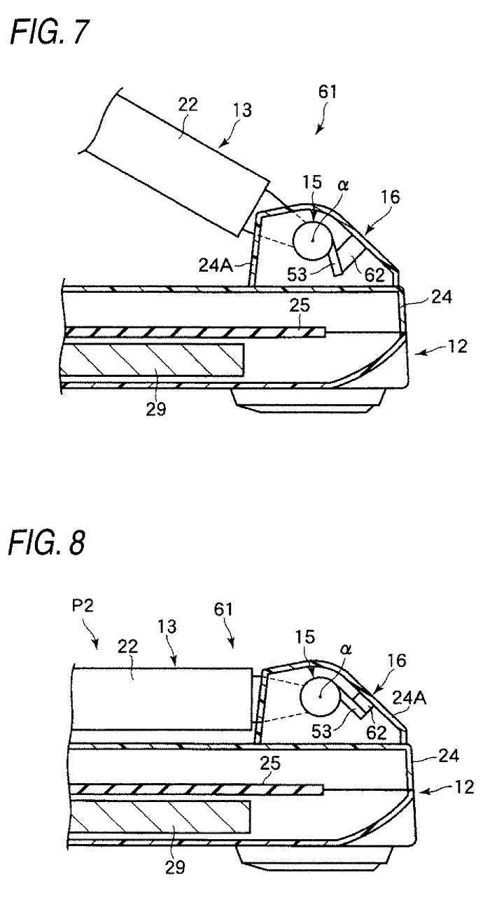

Subsequently, a second embodiment of an electronic equipment will be described with reference to FIGS. 7 and 8 by taking the case where it is applied to a portable computer 61 as an example. The portable computer 61 of the second embodiment differs from the portable computer of the first embodiment only in material of an elastic body 62. Thus, the difference from the first embodiment will be described and parts identical with or similar to those previously described with reference to the accompanying drawings in the first embodiment are denoted by the same reference numerals in FIGS. 7 and 8 and will not be described again.

The elastic body 62 of the second embodiment is formed of square rubber or sponge, for example. Soft rubber or sponge having a large expansion amount is used. The elastic body 62 is pressed by a rotation member 53 rotating with rotation of a display unit 13 as in the first embodiment.

If the user attempts to place the display unit 13 in a second position P2 from a first position P1, an urging mechanism 15 pulls the display unit 13 in the direction of a main unit 12. Immediately before the display unit 13 arrives at the second position P2, the rotation member 53 abuts the rubber or sponge of the elastic body 62 as shown in FIG. 7. When the display unit 13 continues to rotate, the rotation member 53 rotates on a shaft part 35 and gradually crushes the rubber or sponge of the elastic body 62. When the display unit 13 arrives at the second position P2, the elastic body 62 is pressed as shown in FIG. 8. The rotation speed of the display unit 13 is relaxed in reaction to pressing the elastic body 62 and the display unit 13 is gently pulled toward the second position P2.

According to the second embodiment, if the elastic body 62 of a relaxation mechanism 16 is formed of square rubber or sponge, the rotation speed of the display unit 13 can be decreased for preventing the display unit 13 from coming into collision with the main unit 12 with force. The effectiveness of the relaxation mechanism 16 can be finely adjusted by changing the hardness of the rubber or sponge. Accordingly, the case where the weight of the display unit 13 changes due to design change, etc., can be dealt with flexibly.

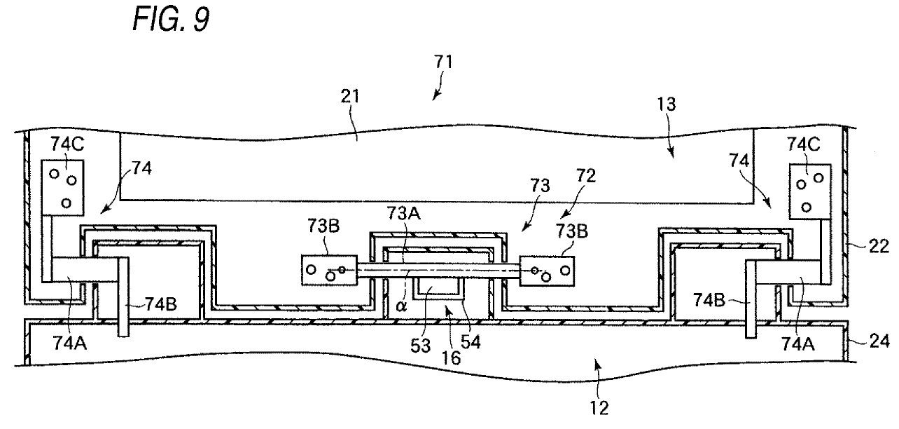

Next, a third embodiment of an electronic equipment will be described with reference to FIG. 9 by taking the case where it is applied to a portable computer 71 as an example. The portable computer 71 of the third embodiment differs from the portable computer of the first embodiment only in the configurations of a hinge mechanism 72 and relaxation mechanism 16. Thus, the difference from the first embodiment will be described and parts identical with or similar to those previously described with reference to the accompanying drawings in the first embodiment are denoted by the same reference numerals in FIG. 9 and will not be described again.

The hinge mechanism 72 of the third embodiment cannot pivot a display unit 13 in a horizontal direction and can rotate the display unit 13 only between a first position P1 and a second position P2. The hinge mechanism 72 has a first hinge part 73 of a rotation shaft placed in the center and second hinge parts 74 placed at both left and right ends. The first hinge part 73 has a first shaft part 73A formed like a rod and a first bracket 73B fixed to both ends of the first shaft part 73A. The second hinge part 74 has a second shaft part 74A and a second bracket 74B and a third bracket 74C supported in the second shaft part 74A for rotation. An urging mechanism 15, which is not shown in the figure, is similar to the urging mechanism in the first embodiment and is provided adjacent to the second hinge part 74.

The relaxation mechanism 16 is provided adjacent to the first hinge part 73. The relaxation mechanism 16 has a rotation member 53 shaped like a flat plate and an elastic body 54 pressed by the rotating rotation member 53. The rotation member 53 is integral with the first shaft part 73A of the first hinge part 73. The relaxation mechanism 16 is formed so as to project from the first shaft part 73A toward the outside. The elastic body 54 is implemented as a plate spring like that of the first embodiment.

If the user is about to place the display unit 13 in a second position P2 from a first position P1 by performing closing operation, the urging mechanism 15 pulls the display unit 13 in the direction of a main unit 12. Immediately before the display unit 13 arrives at the second position P2, the rotation member 53 strikes the elastic body 54 and the relaxation mechanism 16 starts to operate. When the display unit 13 continues to rotate, the rotation member 53 rotates on an axis α passing through the center of the first shaft part 73A and gradually crushes the elastic body 54. When the display unit 13 arrives at the second position P2, the elastic body 54 is pressed. The rotation speed of the display unit 13 is relaxed in reaction to pressing the elastic body 54 and the display unit 13 is gently pulled toward the second position P2.

According to the third embodiment, if the relaxation mechanism 16 is provided in the center adjacent to the first hinge part 73, the relaxation mechanism 16 can relax the shock produced when the display unit 13 strikes the main unit 12. Accordingly, applying a strong shock to the portable computer 71 can be prevented and the reliability of the portable computer 71 can be improved.

The electronic equipment is not limited to the portable computer 11, 61, or 71 shown in the embodiments and the invention can also be applied to any other electronic equipment such as a mobile information terminal, for example. In addition, various modifications of the electronic equipment can be made without departing from the scope and the spirit of the invention, of course.

It is to be understood that the present invention is not limited to the specific embodiments described above and that the present invention can be embodied with the components modified without departing from the spirit and scope of the claimed invention. The present invention may be embodied in various forms according to appropriate combinations of the components disclosed in the embodiment described above. For example, some components may be deleted from all components shown in the embodiment. Further, the components in different embodiments may be used appropriately in combination.

What is claimed is:

1. An electronic equipment comprising:
a main unit that is provided with a printed circuit board;
a display unit that is provided with a display device;
a hinge mechanism that is provided with a rotation shaft that connects the display unit to the main unit to be rotatable between a first position where the display unit is opened relative to the main unit and a second position where the display unit is closed relative to the main unit;
an urging mechanism that urges the display unit toward the second position at a position between the first position and the second position; and
a relaxation mechanism that is provided separately from the urging mechanism and relaxes an urging force applied to the display unit by the urging mechanism.

2. The equipment according to claim 1, wherein the relaxation mechanism decreases a rotation speed of the rotation shaft immediately before the display unit arrives at the second position.

3. The equipment according to claim 2, wherein the main unit is further provided with a cabinet that accommodates the printed circuit board,
wherein the cabinet has a protruded portion that protrudes toward the display unit, and
wherein the relaxation mechanism is housed in the protruded portion.

4. The equipment according to claim 3, wherein the relaxation mechanism is provided with:
a rotation member that rotates along rotation of the rotation shaft; and
an elastic body that is pressed by the rotation member when the.

5. The equipment according to claim 4 further comprising a hard disk drive that is accommodated in the cabinet of the main unit.
